(19) United States
(12) Patent Application Publication
(10) Pub. No.: US 2007/0132296 A1
(43) Pub. Date: Jun. 14, 2007

(54) AUTOMATIC LUMBAR SUPPORT SYSTEM FOR A FOLDING SEAT SYSTEM

(75) Inventors: Alan Sturt, W. Bloomfield, MI (US); Jeff Kempf, Romeo, MI (US); Christopher Lee Armbruster, White Lake, MI (US)

Correspondence Address: ARTZ & ARTZ, P.C., 28333 TELEGRAPH RD., SUITE 250, SOUTHFIELD, MI, 48034, US

(73) Assignee: LEAR CORPORATION, Southfield, MI (US)

(21) Appl. No.: 11/306,007

(22) Filed: Dec. 14, 2005

(51) Int. Cl. B60N 2/02

(52) U.S. Cl. 297/378.12

(57) ABSTRACT

A folding seat system includes a lower seat portion and a seat back pivotally coupled thereto such that the seat back collapses towards the lower seat portion and opens away from the lower seat portion. Coupled to the seat back is a lumbar support basket including an upper pivot rod pivotally coupled widthwise across the seat back and a lower push rod generally parallel to the pivot rod. The lumbar support basket extends outwardly when the push rod moves upwardly in response to engaging a platform on the lower seat portion and flattens when the push rod moves downwardly in response to disengaging the platform.

### TECHNICAL FIELD

The present invention relates to seating in automotive vehicles and, more particularly, to an automobile folding seat system having an automatic lumbar support system.

### BACKGROUND OF THE INVENTION

In vehicles, such as vans, mini-vans and sport utility vehicles, folding passenger seating arrangements are constantly being sought for providing large, unimpeded areas for carrying cargo. It is a constant goal to provide folding passenger seating arrangements including comfortable seats. It is also a constant goal to provide cargo areas having increased volume when the seating is stowed for facilitating loading and carrying large sized cargo.

A number of approaches have been taken to provide this additional cargo room through including folding seating designs. For example, one current solution includes seats detachable from the vehicle. A further example includes seats movable or foldable in a forward direction for creating additional cargo space.

Currently, however, folding seats are generally flat to allow thin folded thickness. Folding seats are generally required to be as flat as possible, when folded, to maximize storage space within the vehicle. This flatness requirement means the seat, when in the upright position, gives little or no support to the lumbar region of the occupant and may therefore be uncomfortable. Further, those current folding seats having substantial lumbar support also generally have a folded thickness not allowing maximum storage space.

It is a known objective of all vehicle manufacturers to maximize the available storage area within the vehicle without significantly increasing its size. Increasing the size of the vehicle can be disadvantageous in that it can increase its cost as well as its weight and thereby decrease its fuel efficiency. It is also a known objective of these manufacturers to provide vehicles having increased seating capacity. A delicate balance must therefore be struck between increasing the storage capability of a vehicle and increasing the seating capacity of the vehicle. Further, while increasing seating capacity, it is a constant goal to improve comfort of vehicle seats. The present invention is directed to these ends.

### SUMMARY OF THE INVENTION

The present invention overcomes the above-stated disadvantages. In one embodiment of the present invention, a folding seat system includes a lower seat portion and a seat back pivotally coupled thereto such that the seat back is collapsible towards the lower seat portion. Coupled to the seat back is a lumbar support basket including an upper rod pivotally coupled widthwise across the seat back and a lower rod generally parallel to the upper rod. The lumbar support basket extends outwardly when the lower rod moves upwardly in response to engaging a section of the lower seat portion and flattens when the lower rod moves downwardly in response to disengaging the section of the lower seat portion.

This embodiment of the present invention provides several advantages. One such advantage is that it maximizes vehicle space usage. A further such advantage is that it maximizes user comfort by providing a folding seat with lumbar support.

The present invention itself, together with further objects and attendant advantages, will be best understood by reference to the following detailed description, taken in conjunction with the accompanying drawings.

### BRIEF DESCRIPTION OF THE DRAWINGS

For a more complete understanding of this invention, reference should now be made to the embodiments illustrated in greater detail in the accompanying figures and described below by way of examples of the invention wherein.

FIG. 1 is a partial cutaway view of an automotive system including a folding seat system in accordance with one embodiment of the present invention.

FIG. 2 is a perspective view of the folding seat system of FIG. 1.

FIG. 3 is a perspective view of the folding seat system of FIG. 1 in operation.

FIG. 4 is a side view of the folding seat system of FIG. 1 in a collapsed position.

FIG. 5A is a close-up view of a push rod system for the folding seat system of FIG. 1 in accordance with another embodiment of the present invention.

FIG. 5B is a close-up view of the push rod system for the folding seat system of FIG. 1 in operation in accordance with another embodiment of the present invention.

FIG. 5C is a close-up partial view of the seat back of the folding seat system of FIG. 5A.

FIG. 5D is a partial side view of the seat back of the folding seat system of FIG. 5A.

FIG. 6A is a close-up view of a lumbar adjuster system for the folding seat system of FIG. 1 adjusted to provide decreased lumbar support, in accordance with another embodiment of the present invention.

FIG. 6B is a close-up view of a lumbar adjuster system for the folding seat system of FIG. 1 adjusted to provide increased lumbar support, in accordance with another embodiment of the present invention.

FIG. 7 is a perspective view of the folding seat system in accordance with another embodiment of the present invention.

### DETAILED DESCRIPTION

While the present invention is described primarily with respect to a folding seat for an automotive vehicle, the present invention may be adapted to various application requiring folding seating, as will be understood by one skilled in the art. For example, the present invention may be applied to stadium seating, airplane seating, seating for aerospace or aeronautical vehicles, or any other vehicle or structure requiring folding seating.

In the following description, various operating parameters and components are described for a number of constructed embodiments.

The specific parameters and components are included as examples and are not meant to be limiting.

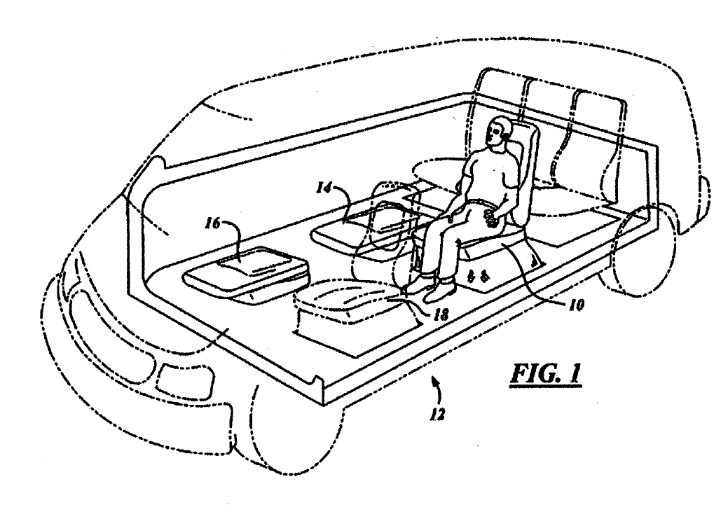

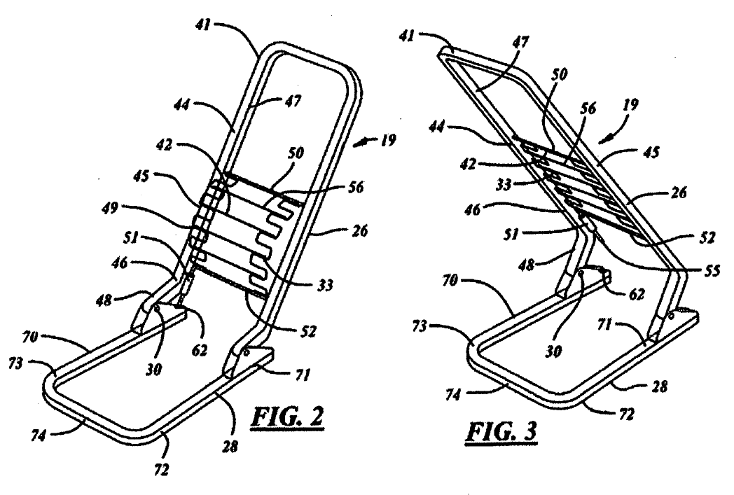

Referring to FIG. 1, a folding seat system 10 within a vehicle 12 is illustrated in accordance with one embodiment with the present invention. The vehicle 12 also includes three other folding seat systems (second folding seat system 14, third folding seat system 16, fourth folding seat system 18), thereby illustrating that any of the vehicle seats may be stowed for providing increased cargo space in the vehicle 12. Important to note is that the seat system 10 is upholstered in FIG. 1, whereas FIGS. 2-6B illustrate unupholstered seat frames 19 for an upholstered seat system 10.

Referring to FIGS. 2-4, a component view of the interior support structure of the folding seat system 10 of FIG. 1 is illustrated. FIG. 2 illustrates a fully opened or upright folding seat system 10, FIG. 3 illustrates a partially opened folding seat system 10, and FIG. 4 illustrates a fully closed or collapsed folding seat system 10.

The folding seat system 10 includes a seat frame 19 having a seat back 26 pivotally coupled to a lower seat portion 28 through a pivot 30 or pair of pivots. The folding seat system 10 includes a lumbar support system 33 coupled to the seat back 26, which will be discussed in detail herein. The seat back 26 and lower seat portion 28 are designed such that the seat back 26 folds towards the lower seat portion 28 for stowing the seat system 10.

One embodiment of the seat system 10 includes a spring mechanism or reactive member (seat actuator system) for springing the seat back 26 into its upright position when the seat frame 19 is opened. However, any known mechanism may be used for unfolding the seat.

The seat back 26 includes an upper portion 41; a middle portion 44; a lower portion 46; a lumbar region 45 between the upper portion 41 and the lower portion 46; an inner edge 47, such that said upper portion 41, the middle portion 44, and the lower portion 46 have the inner edge 47 in common; and a base portion 48 extending outwardly and at an angle relative to said lower portion 46.

Coupled or welded to the lower portion 41 is a push rod tube 51 through which the push rod 52 of the lumbar support system 33 translates, which will be discussed later. Important to note is that, although embodied as having a tube on one side of the seat back, the present invention includes alternate embodiments having tubes on both sides such that the ends of the push rod 52 translate through both tubes.

The seat back 26 is foldable in an upright position 49, illustrated in FIG. 2, and a collapsed position 53, illustrated in FIG. 4. The seat frame 19 deploys the lumbar support system 33, which is mechanically activated as the seat back 26 is moved to the upright position 49. The lumbar support system 33 flattens when the seat back 26 is moved to the collapsed position 53.

The lumbar support system 33 includes a collapsible lumbar basket 42 including an upper pivot rod 50 (first rod or upper rod) pivotally attaching to the middle portion 44 of the seat back 26, a lower push rod 52 (second rod or lower rod), which is substantially parallel to the upper pivot rod 50, having perpendicular ends 55, received within the push rod tubes 51. Between the upper pivot rod 50 and the lower push rod 52 are, in accordance with one embodiment of the present invention, a plurality of substantially parallel rods 56 having ends 58 linked together by a plurality of fasteners 59 (e.g. clamps or crimped fasteners). The ends 58 may be bent such that an end of one of the parallel rods 56 and the end of a lower or upper rod are pivotally coupled within a fastener 59.

Alternately, the parallel rods 56 may extend within the fasteners 59, and joining sections 61 may likewise pivotally couple within the fasteners 59 for joining the parallel rods 56 of the basket 42 together. Numerous other embodiments of the interconnected or mesh configuration of the parallel rods of the basket 42 are also embodied herein.

The lower seat portion 28 includes a top 70, a bottom 72, a top rear 71, a top front 73, and a common side 74. The top 70 is designed such that a passenger may sit thereon. The side 74 is designed with a thickness such that it may fit compactly within a stowage cavity or may occupy a minimal amount of room in a passenger compartment.

Coupled to the top rear 71 are pivot holders 76 to which the pivot 30 attaches for pivoting the seat back 26 relative to the lower seat portion 28. Coupled to the pivot holders are platforms 62 (sections of the lower seat portion 28), which lumbar basket push rod 52 presses against when the seat 19 is in the upright position 49. The sections of the lower seat portion 28 are embodied herein as platforms 62, however, they may further be embodied as latches, hooks, or other means for providing a counter resistance to movement of the lower push rod 52 in one direction as the seat is in the upright position.

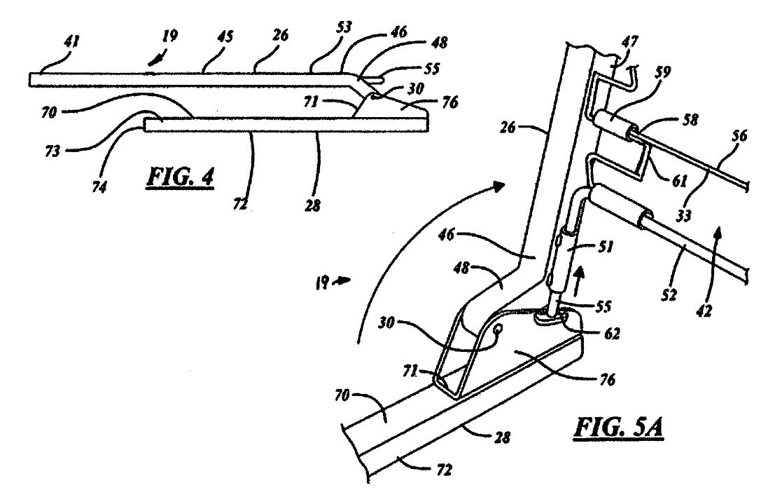

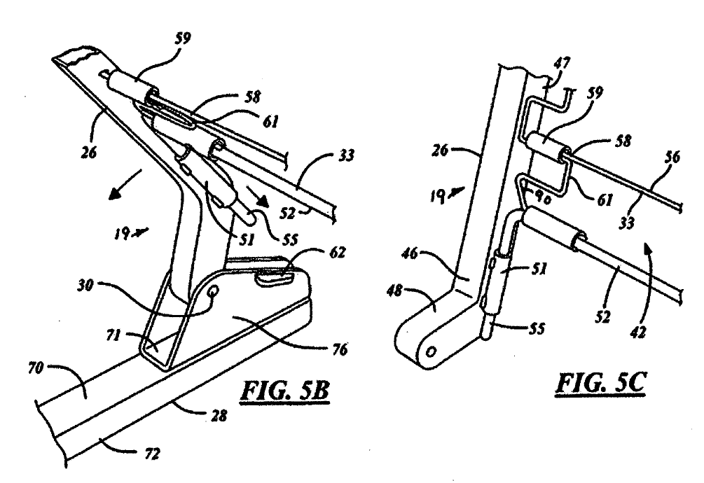

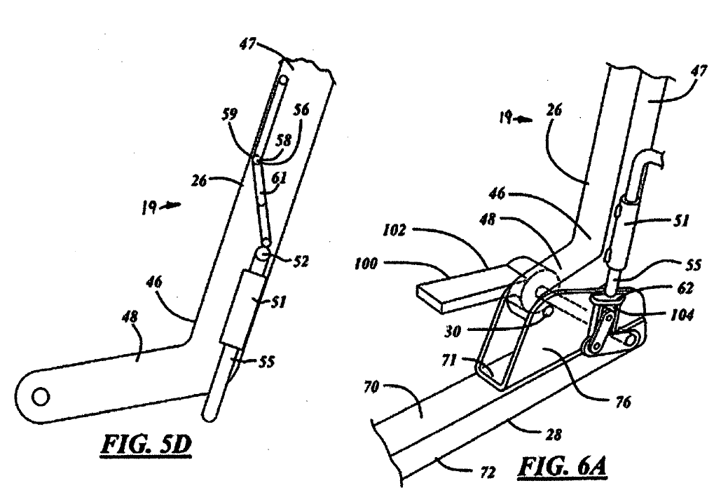

Referring to FIGS. 5A-5D, an operational view of the seat frame 19 is illustrated including arrows demonstrating movement of components of the seat frame 19. The lumbar support system 33 automatically changes from curved to flat when the seat back is moved.

When the seat 19 is placed in the upright position, the lumbar basket push rod 52 presses against the platform 62 and resultantly translates upwards through the push rod tube 51. Because the lumbar basket 42 is attached to the seat back 26 at the upper pivot rod 50, the parallel rods 56 of the lumbar basket 42 are forced outwardly relative to the seat back 26 responsive to the translation of the push rod 52.

FIGS. 5C and 5D illustrate that a lower side connector 90 is biased toward the lower seat portion 28 such that the lumbar basket 42 is forced outwardly in a proper manner. In other words, an upward force of the push rod 52 results in the proper outward force of the basket 42 in the lumbar region of the seat.

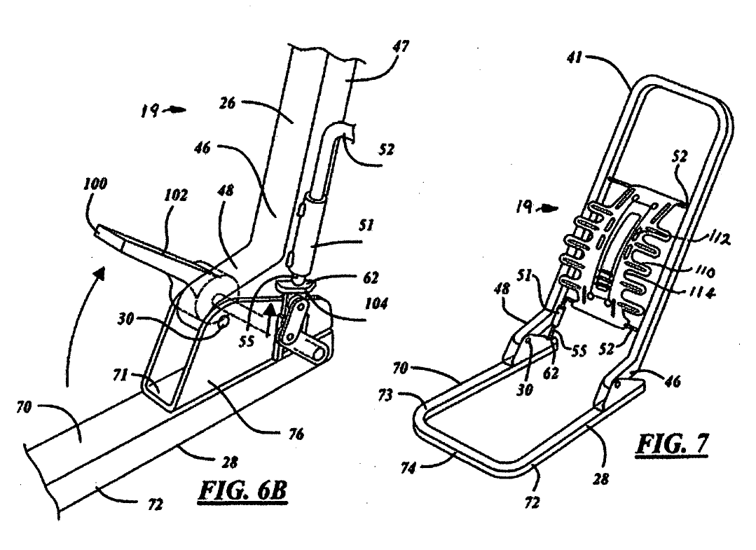

Referring to FIGS. 6A and 6B, an alternate embodiment of the seat frame 19 is illustrated in accordance with another embodiment of the present invention. In this embodiment, the seat frame 19 operates with a lumbar comfort adjuster 100. One possible scheme for the adjuster 100 is shown.

The adjuster 100 includes a ratcheting handle 102 rotating a lever system 104, which raises or lowers the platform 62 on which the lumbar basket push rod 52 sits. This does not interfere with the folding of the seat frame 19, and the lumbar comfort adjuster 100 adjustment will be retained when the seat frame 19 is brought back to the upright position. Further, the lever system 104 may include a plurality of predetermined positions such that the comfort adjustment of the system 10 may be tailored closely to an individual passenger or a variety of passengers.

Referring to FIG. 7, an alternate embodiment of the seat frame 19 is illustrated in accordance with another embodiment of the present invention. In this embodiment, the basket is embodied as a single thin sheet basket 110 of flexible material, such that the sheet basket 110 bends to form a lumbar support as a function of the interaction of the platform 62 and the push rod 52 as discussed above. The sheet basket 110 defines openings 112 for facilitating bending and reducing stress on the sheet 110. The sheet basket 110 may also include other design features, such as a recessed portion 114, for adjusting flexibility of various portions thereof for providing increased passenger comfort. The sheet basket 110 may also include a combination of sheets including different materials, such as plastics, as will be understood by one skilled in the art.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A folding seat system comprising:
a lower seat portion;
a seat back pivotally coupled to said lower seat portion such that said seat back is collapsible towards said lower seat portion; and
a lumbar support basket comprising an upper rod pivotally coupled widthwise across said seat back and a lower rod generally parallel to said upper rod, whereby said lumbar support basket extends outwardly when said lower rod moves upwardly in response to engaging a section of said lower seat portion and flattens when said lower rod moves downwardly in response to disengaging said section of said lower seat portion.

2. The system of claim 1, wherein said seat back further comprises a push rod tube coupled lengthwise to a lower portion of said seat back.

3. The system of claim 2, wherein said lower rod comprises at least one perpendicular end.

4. The system of claim 3, wherein said at least one perpendicular end moves through said push rod tube and moves upwardly as said seat back is made upright in response to said engaging of said section of said lower seat portion and downwardly as said seat back collapses.

5. The system of claim 1, wherein said section of said lower seat portion comprising at least one of a platform and a latch coupled to said lower seat portion.

6. The system of claim 1 further comprising a lumbar adjuster raising said section of said lower seat portion for adjusting an amount said lumbar support basket extends outwardly.

7. The system of claim 6, wherein said lumbar adjuster comprises a ratcheting handle rotating a lever system for raising and lowering said section of said lower seat portion.

8. The system of claim 1, wherein said lumbar support basket further comprises at least one of:
a plurality of substantially parallel rods between said upper rod and said lower rod comprising ends linked together by a plurality of fasteners; and
a thin single sheet of material.

9. The system of claim 8, wherein said ends are bent such that an end of one of said plurality of substantially parallel rods and an end of an adjacent one of said plurality of substantially parallel rods are pivotally coupled within a fastener.

10. The system of claim 8, said plurality of substantially parallel rods extend within said fasteners, said lumbar support basket further comprising joining sections pivotally coupled within said fasteners for joining said plurality of substantially parallel rods of said lumbar support basket together.

11. A folding seat system for a vehicle comprising:
a lower seat portion;
a pivot holder coupled to said lower seat portion;
a platform coupled to said pivot holder;
a seat back pivotally coupled to said lower seat portion through said pivot holder,
said seat back having an upright position and a collapsed position, said upright position defined by said seat back at an obtuse angle relative to said lower seat portion, said collapsed position defined by said seat back substantially parallel to said lower seat portion,
said seat back comprising a push rod tube fixedly coupled along a lower portion of said seat back, such that said push rod tube is substantially parallel to said seat back; and
a lumbar support basket comprising a pivot rod coupled widthwise across said seat back and a push rod generally parallel to said pivot rod having at least one perpendicular end,
wherein said at least one perpendicular end of said push rod moves through said push rod tube, wherein said at least one perpendicular end moves upwardly when said seat back is positioned in said upright position and downwardly as said seat back is positioned in said collapsed position,
said lumbar support basket comprising a support position and a flat position, said support position defining an arc relative to said seat back in a lumbar region of said seat back when said seat back is in said upright position and said at least one perpendicular end engages said platform, said lumbar support basket in said flat position when said at least one perpendicular end is free from engaging said platform.

12. The system of claim 11 further comprising a lumbar adjuster raising said section of said lower seat portion for adjusting an amount said lumbar support basket extends outwardly.

13. The system of claim 12, wherein said lumbar adjuster comprises a ratcheting handle rotating a lever system for raising and lowering said platform.

14. The system of claim 11, wherein said lumbar support basket further comprises at least one of: a plurality of substantially parallel rods between said upper rod and said lower rod comprising ends linked together by a plurality of fasteners; and
a thin single sheet of material.

15. The system of claim 14, wherein said ends are bent such that an end of one of said plurality of substantially parallel rods and an end of an adjacent one of said plurality of substantially parallel rods are pivotally coupled within a fastener.

16. The system of claim 14, said plurality of substantially parallel rods extend within said fasteners, said lumbar support basket further comprising joining sections pivotally coupled within said fasteners for joining said plurality of substantially parallel rods of said lumbar support basket together.

17. A folding seat system for a vehicle comprising:
a lower seat portion;
a pivot holder coupled to said lower seat portion;
a platform coupled to said pivot holder;
a seat back comprising an upper portion, a middle portion, a lower portion, a lumbar region between said lower portion and said middle portion, a base portion extending outwardly at an angle from said lower portion, said seat back pivotally coupled to said lower seat portion through said lower portion of said seat back,
said seat back having an upright position and a collapsed position, said upright position defined by said seat back at an obtuse angle relative to said lower seat portion, said collapsed position defined by said seat back substantially parallel to said lower seat portion,
said seat back comprising at least one push rod tube fixedly coupled along said lower portion of said seat back, such that said push rod tube is substantially parallel to said seat back; and
a lumbar support basket comprising a pivot rod coupled widthwise across said seat back in said lumbar region and a push rod generally parallel to said pivot rod having at least one perpendicular end, coupled to said push rod and said pivot rod and positioned therebetween are a plurality of parallel rods having ends coupled together such that said plurality of parallel rods move laterally while remaining parallel to each other,
wherein said at least one perpendicular end of said push rod moves through said push rod tube, wherein said at least one perpendicular end moves upwardly when said seat back is positioned in said upright position and downwardly as said seat back is positioned in said collapsed position,
said lumbar support basket defining a support position and a flat position,
said support position defining an arc, formed of said plurality of parallel rods, relative to said seat back in said lumbar region of said seat back when said seat back is in said upright position and said at least one perpendicular end engages said platform, and said lumbar support basket in said flat position when said at least one perpendicular end is free from engaging said platform.

18. The system of claim 17 further comprising a lumbar adjuster raising said platform for adjusting an amount said lumbar support basket extends outwardly.

19. The system of claim 18, wherein said amount comprises at least a first predetermined amount and a second predetermined amount.

20. The system of claim 18, wherein said lumbar adjuster comprises a ratcheting handle rotating a lever system for raising and lowering said platform.
